(19) United States
(12) Patent Application Publication
(10) Pub. No.: US 2008/0129038 A1
(43) Pub. Date: Jun. 5, 2008

(54) Printed Article with Improved Definition and Depth

(75) Inventor: Joel Scott Scarbrough, Lindenhurst, IL (US)

Correspondence Address: GODFREY & KAHN S.C., 780 NORTH WATER STREET, MILWAUKEE, WI, 53202, US

(73) Assignee: SERIGRAPH INC., West Bend, WI (US)

(21) Appl. No.: 11/566,517

(22) Filed: Dec. 4, 2006

(51) Int. Cl. B42D 15/00

(52) U.S. Cl. 283/91

(57) ABSTRACT

A printed article comprising a substrate; a graphic image formed over the surface of the substrate; and a textured pattern printed over the graphic image with an embossed appearance and the capability of containing hidden images and unique security features. The textured pattern formed of a number of lines, formed in adjacent sections over the surface of the graphic image. The lines of each section are all substantially parallel to each other and oriented in a first direction, and the lines of a directly adjacent section are all substantially parallel to each other and oriented in a second direction different from the first direction, such that the plurality of parallel lines in each section reflect light in a direction different than that of each adjacent section. Each of directions of the lines is selected so as to minimize any errors introduced by equipment used to create the lines.

### BACKGROUND OF THE INVENTION

The present invention relates generally to a secure printed article, and more particularly to a printed article having a graphic design such as a trading card, greeting card, sign, poster, label, decal, book cover, decorative panel, name plate, credit card, visual display and the like having an uncopyable image with a textured pattern printed thereon creating visual illusions of depth, three-dimensionality, hidden images or motion in the printed article.

In order to attract the attention of consumers, many products are manufactured with images that provide a unique and sensational visual presentation. To meet this demand, a variety of printing techniques have been developed to produce aesthetically pleasing visual effects, such as the appearance of depth, three-dimensionality and motion. In addition, various methods are known in the prior art that produce hidden or latent images and three-dimensional images on two-dimensional media.

One method involves printing two offset images in different colors on an opaque or transparent sheet, and viewing the images using special glasses having right and left lenses which correspond to the different image colors respectively. This method is limited in that to see the visual effect the viewer must observe the image typically through special glasses.

Another method to achieve a sensational visual presentation is the use of lenticular material. In lenticular articles an array of parallel convex lenses is formed over a clear plastic substrate, where the parallel lenses magnify slices of images printed under them. Different viewing angles focus on different slices of the images such that an overall image is seen at one viewing angle and a different image is visible at another viewing angle. This can result in three-dimensional images, a simple image A to image B flip or multiple images that show a series of images from one viewing angle to another resulting in the appearance of viewing a motion video clip. Despite the variety of possible effects, lenticular articles have had limited success as manufacturing expense is very high, material costs are high and substrates are limited.

Another method is taught in Sax, U.S. Pat. No. 5,741,578, which describes a method of creating latent or hidden image using reflective characteristics of differing gloss levels. A transparent image of one gloss level is printed over a graphic image printed in a different gloss level. The transparent latent or hidden image is visible when viewing at an angle of reflected light where the different gloss levels highlight the transparent image in contrast with the graphic image. This method has limited commercial success as the hidden or latent image is difficult to observe because the hidden image is transparent and only visible under certain lighting conditions.

Holographic technology has also been used to produce an image on a two dimensional article which appears three-dimensional when illuminated and viewed at the proper angles. Holograms have traditionally been used to provide both a unique visual effect and for security purposes. A significant drawback of holograms is that they are difficult and expensive to produce.

One process to produce the illusion of three-dimensional images on two-dimensional media is conventional embossing, which forms a raised pattern on a substrate by physically deforming part of the substrate. However, embossing suffers from the drawback that an expensive high tonnage press is necessary to perform the operation, and an expensive die bearing the desired embossed pattern must be made for each application. Further, the materials that can be used for embossing are limited because of the deforming nature of the embossing process.

Fairly recently developed methods to simulate the visual impact of embossing use various applications of thick textures typically applied in a printing operation. Although these innovations have offered improvements over prior methods, they also have substantial shortcomings.

Longobardi, U.S. Pat. No. 4,933,218 teaches the use of a thick transparent ink printed on the back surface of a transparent substrate with a subsequent layer of a reflective film married over the thick transparent ink such that the reflective film substantially conforms to the thick transparent ink. The resulting article appears to be embossed because of the substantial conformance of the reflective film to the thick transparent ink. Salmon, U.S. Pat. No. 5,762,379 teaches a similar effect, but on the first surface of almost any substrate. A thick ink, which does not have to be transparent, is printed onto the top surface of a substrate and a reflective layer is applied over the thick ink, substantially conforming to the thick ink, also resulting in an embossed appearance. These inventions require application of the thick ink followed by a separate operation of application of the reflective layer over the texture.

McElhatton, U.S. Pat. No. 6,701,652 teaches a novel method of imparting an embossed appearance to a reflective layer during a molding process. McElhatton describes using a thick deposit of a non-thermoplastic clear ink onto a thermoplastic reflective substrate. This article is then placed into a mold and clear molten plastic is injected into the mold. The temperature and pressure of the mold and the molten plastic combine to soften the thermoplastic reflective substrate. The non-thermoplastic thick ink impresses into the softened thermoplastic reflective substrate because of the heat and pressure in the mold causing the texture of the non-thermoplastic thick ink to permanently deform the reflective substrate. This effectively embosses the reflective substrate without the need for a separate embossing process. Although beneficial in the molded product industry, this method has not proven useful for normal printed articles that are not subjected to costly molding operations.

Scarbrough, U.S. Pat. No. 6,979,487 teaches application of a transparent thick ink onto the surface of a reflective substrate and the use of a layer of clear gloss coating or laminate such that the thick transparent ink and the overall gloss levels are equivalent. This arrangement effectively hides the thick transparent ink, resulting in the article appearing embossed, similar to Longobardi and Salmon patents, yet eliminating the need for a separate application of a reflective layer over the thick ink. Scarbrough '487 allows for almost any substrate to be printed with graphics, thick transparent textures and overall gloss in one step. As opposed to Longobardi and Salmon, which both use physical deformation of a reflective substrate to bend light showing the apparent embossing, Scarbrough '487 uses the reflective characteristic of transparent ink to bend light to appear embossed, resulting in a finished product that can be used on almost any substrate and produced in one continuous printing operation.

U.S. Patent Application Publications 20030205895 and 20040140665 and PCT Application Publication WO 02/076759, collectively referred to as “Early Micromotion Applications” teach the concept of using a thick application of clear transparent ink to create novel, unique effects. The Early Micromotion Applications describe the use of fine parallel lines of the thick transparent ink controlling the direction of reflected light. By printing the fine parallel lines in one direction in one region and in a different direction in another region, the reflected light is gathered and directed into one direction in one region and another direction in the other region. When the printed article is viewed from one direction, one region appears glossy and the other appears matte because of the direction of the controlled reflected light. When the viewing angle is changed, the gloss levels change, for one particular region from glossy to matte while another region changes from matte to glossy. This resulting change of gloss level creates an illusion of motion of the reflected light, an effect referred to herein as the Micromotion Effect.

The transparent ink used to form the Micromotion Effect has rheological properties such that when it is applied, it flows into a semi-cylindrical or other convex shape when viewed in cross-section. These convex shape lines produce a desirable reflective textured pattern on the surface of the printed article. However, the requirement that undesirable bleeding or flooding of the ink outside of the lines be prevented has limited the height, thickness, gap between lines and/or application speed of the textured pattern. These limitations permit the Micromotion Effect to be only visible on highly reflective surfaces and with graphics that consist of large monochrome areas, as the Micromotion Effect is overpowered by the strength of color changes in the graphics.

The force applied to ink or coating by the printing equipment is called shear force, a term that can be applied to any force that causes ink to flow. In nearly any printing operation, the printing equipment applies a shear force to the ink. Depending upon the magnitude of the shear force, often determined by the speed of the ink application, the ink may flow outside of the predetermined lines or areas where it was intended to go, causing “bleeding” or “flooding” of ink. Conventionally, the ink or other coating may be applied through silk screening, lithography, flexography and other known printing techniques. In the case of silk screening, for example, as the squeegee moves forward it begins to apply force to the ink rather than to the screen. As the squeegee moves across the screen, it sweeps a wave of ink before it. The force generated within this wave pushes ink through the mesh and down onto the substrate. If the force generated is great enough, microscopic turbulence and surface tension may result in bleeding of ink outside the intended contact area. Similar mechanisms apply for other printing techniques.

There is need to overcome at least some of the abovementioned problems in providing an improved design creation and printing method for printing images on a printed article having the illusion of motion, depth and dimensionality.

Another use of unique visual effects and hidden or latent images has been for security purposes. Lenticular, holographic, hidden images, watermarks, invisible tagants, and chemical reactant species have all been used for their authenticity verification and security aspects.

Green, U.S. Pat. No. 5,851,032, describes a method to produce hidden or latent images as a security feature by using a layer of light transmitting material, with a pattern of non-light transmittance, overlaid onto a layer with a pattern where the light transmitting material correlates to an apparently random pattern within the printed article to reveal the hidden or latent pattern. Green also discloses a method of printing a layer of a pattern of light blocking and light transmitting regions such that when a light source is placed behind the article, the light transmission is partially blocked, revealing the hidden or latent pattern. This requires the use of a transparency to view the hidden image where some light is blocked by a pattern to reveal a message.

Microtaggants, that is, particles with distinctive characteristics visible only under microscopic magnification, have been used for authenticity verification. Chemically reactive species have been added which react to certain conditions such as ultraviolet light, changing color with a temperature change, or changing color when subjected to a change in acidity.

The methods described above have not been commercially popular on economical printed articles for various reasons. The offset image method is undesirable in that special glasses are required to view the image. The transparent images of Sax do not contain any color, just a gloss or dull ghost of an image. Lenticular imaging requires expensive materials and difficult manufacturing conditions. Reactive species often require destruction of the article for verification. Microtaggants and holograms are expensive. An economical method to prevent digital or photographic copies does not exist in combination with an economical method to verify authenticity. Additionally, an economical method to produce hidden images, which provides additional security features and a unique visual presentation, has heretofore been unavailable.

Reference to any prior art in the specification is not, and should not be taken as, an acknowledgement or any form of suggestion that this prior art forms part of the common general knowledge in any jurisdiction or that this prior art could reasonably be expected to be ascertained, understood and regarded as relevant by a person of ordinary skill in the art.

### SUMMARY OF THE INVENTION

In one embodiment of the present invention there is provided a printed article including a substrate having a top surface; a graphic image formed over the top surface of the substrate; and a textured pattern of transparent parallel lines printed in sections over the graphic image, wherein the angle or angles of the transparent parallel lines relative to the mechanical shear imposed onto the ink during application of the ink to the article are selected to prevent ink bleeding from the parallel lines.

The ability to print accurate fine design details with the transparent ink has been limited by the rheology of the transparent ink, the mechanical stresses imposed by printing plates and printing direction, and the accuracy of the re-creation of the artwork from the digitally accurate design to the mechanical imperfection of film, plate or screen output required for subsequent printing of the design. The identification and correction of this set of errors led to unexpected results. Overcoming many of the sources of inaccuracy results in the ability to print significantly more detailed designs and thicker textures, dramatically improving the visual impact of the Micromotion Effect. The invention now makes it possible to hide images under the Micromotion Effect, to improve the height of simulated embossed effects, and to increase the depth of subsequent embossing of the Micromotion Effect down into a soft reflective substrate, and other as yet unknown design possibilities.

The selection of the angles of the transparent texture design of sections of parallel lines to avoid bleeding or flowing together of the parallel lines ensures that the printed article has a sharp and clear image. By controlling the angles of the transparent parallel lines, the height and/or thickness of the lines can be increased without bleeding occurring. In addition, for the same comparative line height and thickness, the distance between the parallel lines may also be decreased without the risk of ink from adjacent lines bleeding or flooding into each other. This increases the visual illusion of motion, the Micromotion Effect, by increasing the amount of light-controlling parallel lines of transparent ink versus non-light-controlling space between the parallel lines of transparent ink.

The ability to print thick textures with substantially increased height and close proximity of adjacent texture lines is not only influenced from the mechanical printing process but heretofore unaccounted for inaccuracies in the digital information creation, the output device, and the printing plate or film from which printing screens are made. The digital information is subject to errors when created in one software system and translated into another, such as from a vector-based image processor to a raster-based image processor, or vice versa. Fine parallel lines maintain their exact dimensions along one axis, whereas along a perpendicular axis the dimensions are increased by software errors in data processing. These errors result in parallel lines approaching this axis being thicker than originally designed, and thereby the lines are packed closer together, which results in a greater likelihood of bleeding or flooding together of these parallel lines. As one example, when Corel Draw files are output to Adobe PDF format, this error is most noticeable in the horizontal parallel lines of an image.

Choice of output device or equipment to create the lines also introduces errors to the accuracy of parallel line thickness and of the spacing between parallel lines. Ink jet devices, which spray ink onto a film or printing plate to be subsequently exposed to create the printing plate or printing screen, print accurate thickness of parallel lines when the direction of movement of the ink jet printing head is parallel with the direction of the lines printed, whereas parallel lines running perpendicular to the direction of the movement of the ink jet head are printed thicker than the original digital files. This error is typically not noticeable for standard printing requirements, but is sufficient to result in the inability to print uniform line height, thickness and spacing when tolerances are very tight. Printing heretofore thicker transparent textures of sections of parallel lines can now be compensated by eliminating angles of parallel lines running perpendicular to the output device printing direction, and or digitally adjusting the thickness and spacing of parallel lines that will be output at directions perpendicular to the output printing device.

As indicated above, depending upon the magnitude of the shear force, often determined by the speed of the ink application, the ink may flow outside of the predetermined areas, causing bleeding. By controlling the relative angle between the shear forces mechanically imposed on the ink and the angle of the parallel lines, this bleeding can minimized. It will be appreciated that a number of other variables will also contribute towards the likelihood of bleeding from the parallel lines, including the use of improved thixotropic ink, and the surface tensions of the ink and substrate.

Another heretofore unidentified error has also been identified and eliminated by the present invention. This defect resulted from the printing plate or printing screen in combination with the anilox or gravure etching or the screen mesh orientation, and with the shear forces during the printing operation. Errors were thus caused in the accurate deposition of the thick transparent texture ink. The printing plate in combination with anilox or gravure etching introduces errors when the angle of etching, which is typically 60 degrees from the horizontal face of an anilox or gravure cylinder, is combined with the physical stresses imparted during printing the transparent texture of sections of parallel lines. The angle of the etching allows the anilox or gravure cylinder to microscopically carry more ink along the 60 degree angle than any other angle. This microscopic difference results in more ink being deposited onto the printing plate along these angles and subsequent increase in width and decrease in spacing between parallel lines of the transparent texture when printed in this direction causing more bleeding or flooding of lines printed in this direction. Screen printing brings about a similar source of error, as printing screens are typically made of fine threads running in two main directions to form the mesh of a printing screen. The screen mesh direction and the squeegee printing direction combine to introduce thicker parallel lines in the directions of the shear of the squeegee and screen threads.

The angles of the transparent parallel lines in each section are thus susceptible to errors imparted from the relative direction of printing, of shear, of squeegee movement, of the etching of anilox or gravure rolls, and also due to film output errors and digital raster image processing errors. According to the invention, specific angles are selected based on minimizing and compensating for these errors to achieve heretofore unachievable texture height and close packing together of parallel lines of the transparent texture ink within a section, and avoiding bleeding, flooding, and flow of the transparent texture ink.

Substrates such as polyethylene and polypropylene are examples of low energy surfaces. The forces between the hydrocarbon molecules that make up the polymers are weak and consequently polar liquids tend to form droplets on the surface rather than spread out. It is difficult to coat low energy surfaces but fortunately there are numerous ways of converting low energy into high energy surfaces. All the methods aim to form oxygen containing species at the surface and this oxidation can be achieved by exposure to ultraviolet radiation, plasma or corona discharge or by flame or acid treatment. Surface energy is quantified in terms of the forces acting on a unit length at the solid-liquid interface. The shear force from the application of the ink to the substrate surface effectively increases the surface energy in the direction of the shear, thus promoting the ink to spread out further in this direction than if no shear force was applied to the ink.

In another embodiment of the present invention the height of the transparent parallel lines is further enhanced by running a transparent UV cured ink that is made specifically to exhibit thixotropic rheological properties. The thixotropic rheology of the transparent ink results in a high viscosity of the ink when under the shear forces of the printing operation. To achieve this high viscosity of the ink with a standard shear thinning or non-thixotropic rheology of normal inks would result in an ink that is too viscous for normal printing operations. Thus, the thixotropic ink can be easily printed and under the high shear stresses of the printing process the ink transfers to the substrate in a highly viscous state resulting in a higher deposition of the transparent lines. As in the first embodiment, the selection of the angles of the parallel lines of the transparent texture is accomplished by running a test pattern to determine which particular angles of lines avoid bleeding of the ink from one of the parallel lines into the next.

It is another embodiment of the present invention to form a graphic image including a plurality of ink layers printed onto a reflective substrate having at least one hidden or latent image lightly printed among the ink layers above the reflective substrate and below the transparent textured pattern of sections of parallel lines. These hidden or latent images are “weak” or “lightly” printed images that are printed among the plurality of ink layers of the graphic design, and are visible only at certain viewing angles. The hidden images appear and disappear from a viewer as the viewing angle of the printed article is changed. The “noise” of the reflected light from the transparent textured pattern of sections of parallel lines “hides” the hidden or latent image, and a viewing angle that does not scatter the reflected light from the transparent textured patterns of sections of parallel lines allows the viewer to see through this texture to see the hidden image. The difference in reflected light from the reflective substrate and the light reflecting off the surface texture is further enhanced by selectively printing an opaque ink on the surface of the reflective substrate and only underneath the image desired to be hidden. The select opaque ink prevents the reflective substrate from reflecting light under the hidden image to enhance the visibility of the hidden image. This enhancement of visibility only occurs when the angle of reflecting light is such that the light is not reflecting off the surface texture and is reflecting off the reflective substrate. In addition, when light is reflecting off the surface texture, it is not penetrating and reflecting off the reflective substrate, thereby increasing the invisibility of the select opaque ink and hidden image.

The ability to emboss intricate designs and patterns into reflective substrates requires the use of expensive embossing equipment, embossing dies, and difficult manufacturing operations. Unlike McElhatton '652, this embodiment allows for the texture to be embossed onto a reflective surface of a thermoplastic using heat and/or pressure. McElhatton '652 teaches a printed texture embossing into the underside of a reflective thin film by being placed into an injection molding machine, where the heat and pressure of the melted mold resin encapsulate the embossed thin reflective film in the mold resin.

In this embodiment of the present invention there is provided a method of physical deformation of the reflective substrate by using a transparent non-thermoplastic ink as a texture printed onto the surface of a thermoplastic reflective substrate. The thermoplastic reflective substrate will usually be printed with any desired graphics and/or colors prior to printing of the transparent non-thermoplastic texture. Physical deformation of the transparent non-thermoplastic texture into the reflective substrate eliminates the need for expensive embossing dies, which would typically be required to emboss texture effects into reflective substrates. This construction is subsequently placed under heat and or pressure to soften the thermoplastic reflective substrate and impress the non-thermoplastic transparent texture into the thermoplastic reflective substrate.

A further embodiment utilizes the improvements provided by the invention to increase the depth of textures described herein, in combination with the use of graphic images and transparent textured designs of sections of parallel lines printed on a transparent substrate. Here the surface of the transparent textured design is formed of sections of parallel lines, and is then laminated with a thin reflective material, or printed with a reflective ink, such that the reflective surface substantially conforms to the texture of the sections of parallel lines. The texture of the sections of parallel lines results in a printed article which appears to be embossed into the reflective material, creating the Micromotion Effect when viewed from different angles.

In another embodiment of the present invention, vacuum metallization of a textured design vapor deposits a highly reflective layer, typically a layer of aluminum, substantially conforming to a texture design which subsequently appears to be embossed or etched into the reflective layer. This improvement simulates embossing of the reflective surface without the expense of traditional embossing. The present invention uses a specially developed UV ink with very low migratory tendencies and a surface tension allowing vacuum metallization to adhere to the graphics and textures. This process eliminates the laminating step and replaces it with high speed economical vacuum metallization. Further, vacuum metal deposition also results in a layer only angstroms thick, thereby eliminating the loss of substantial conformation to the texture from laminates which are substantially thicker, typically 0.005″ or thicker.

Another advantage of the present invention is that it provides an alternative economic solution to problems of counterfeit protection and verification of authenticity, by utilization of transparent texture printing, of sections of parallel lines at different angles in adjacent sections, to prevent counterfeiting and recognize the original printed article as an original. The method of printing the transparent surface texture of sections of parallel lines at different angles provides a unique security feature. The sections of parallel lines each reflecting light to different directions cannot be copied by traditional methods. Office copiers, photography, and scanning equipment rely on reflected light to capture the image. The sections of parallel lines in the present invention prevent the copy, photograph, or scan from accurately capturing colors printed onto a reflective surface and under the sections of parallel lines. Each section will be captured electronically or photographically as a different shade of the color based on the direction of the parallel lines printed over the color. This provides an economic and unique anti-counterfeiting characteristic to graphics utilizing this textured effect of sections of transparent parallel lines printed over graphics printed onto a reflective substrate.

Other objects and advantages will become apparent hereinafter.

### BRIEF DESCRIPTION OF THE DRAWINGS

The invention is explained in more detail herein below by way of exemplary embodiments and with reference to the drawings, in which:

FIG. 1 is an enlarged cross-sectional view of one embodiment of a printed article produced in accordance with the present invention;

FIG. 2 is a top plan view of a trading card having a textured pattern with differing parallel angles in accordance with the present invention.

FIG. 3 is a top plan view of a trading card having a hidden image under a textured pattern with differing parallel angles in accordance with the present invention.

FIG. 4 is a cross-sectional view of a printed article prepared in accordance with another embodiment of the present invention, and having a textured pattern of non-thermoplastic ink embossed into a reflective thermoplastic substrate.

FIG. 5 is a cross-sectional view of a printed article according to another embodiment of the present invention printed on the second surface of a transparent substrate having a reflective layer deposited over the graphics and transparent texture on the back surface.

FIGS. 6 and 7 are top plan views of a printed article according to one embodiment of the present invention showing the appearance of the printed article when viewed from different angles.

### DETAILED DESCRIPTION OF THE EMBODIMENTS

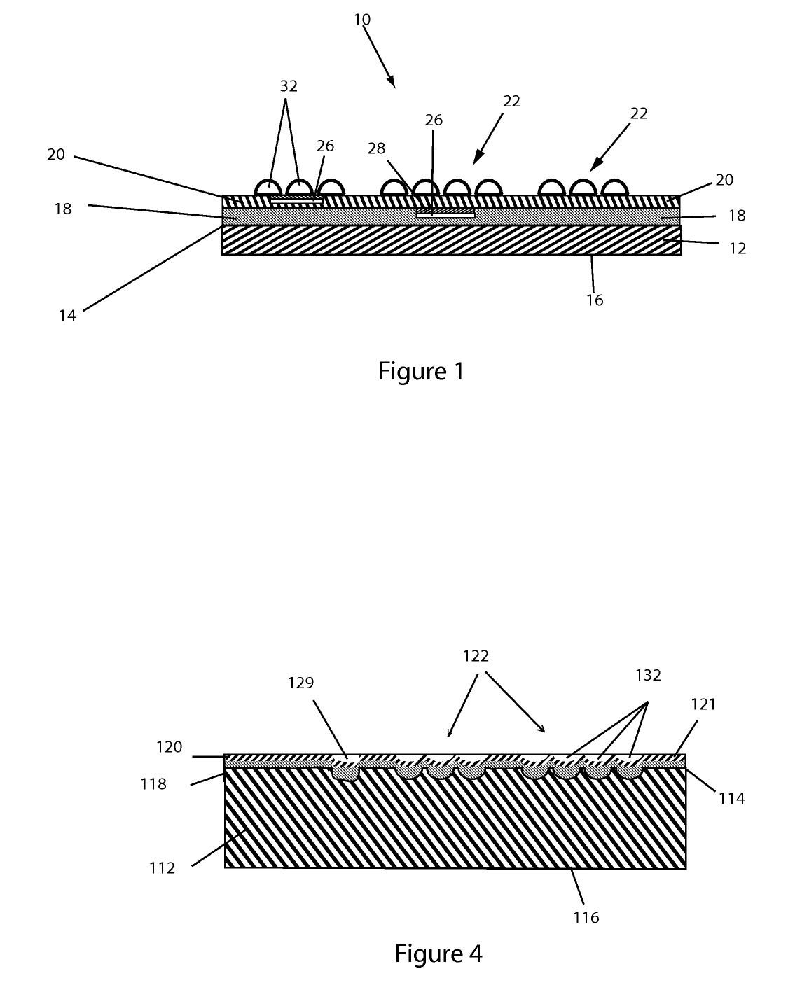

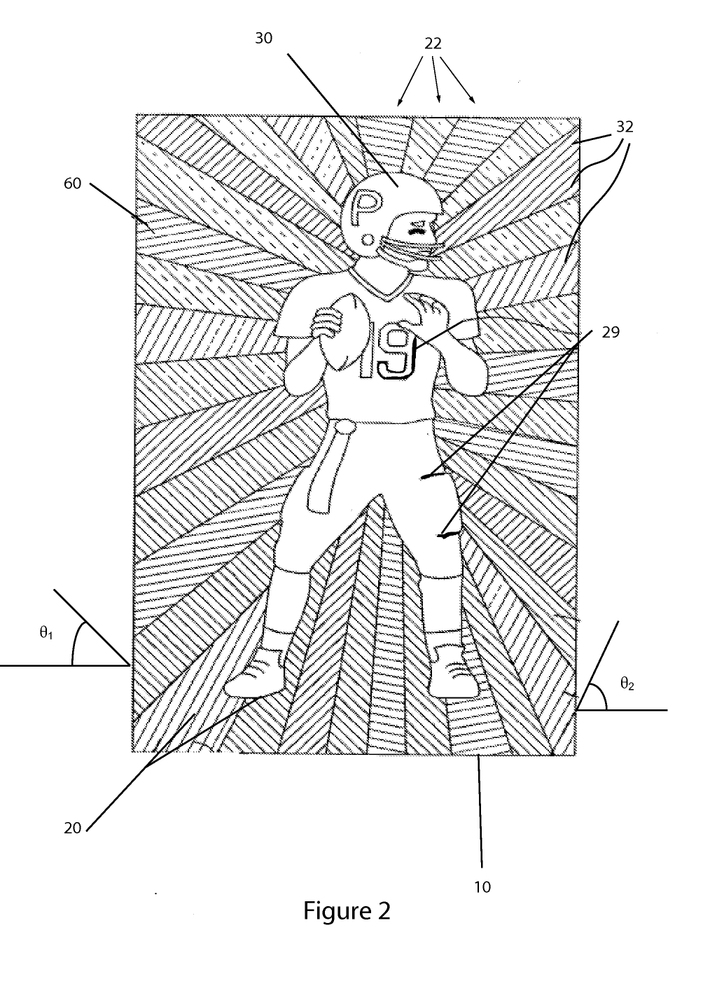

Referring now to FIG. 1, there is shown a cross sectional view of a first embodiment of a printed article 10 produced in accordance with the present invention, depicted on a much enlarged basis over actual size. FIG. 2 illustrates a top view of this embodiment of the printed article 10. In this embodiment, the printed article 10 includes a substrate 12 having a top surface 14 and a bottom surface 16. The substrate 12 can be formed of paper, cardboard, plastic, acrylic, glass, metal or any other suitable printable material.

A layer 18 is preferably printed or laminated with a reflective ink over all or a portion of the top surface 14 of the substrate 12. While a reflective layer is preferred, it will be appreciated that the increased thickness of the textured effect in the present invention enables great visual effects to be achieved on even plain paper substrates. The layer 18 can be clear or have any color. The layer 18 can be opaque, transparent, semi-transparent or translucent. The layer 18 preferably gives the printed article a shiny or glossy metallic appearance. Alternatively, the reflective layer 18 can be formed of a chrome film, diffraction film, metallic foil, holographic foil, roll leafing, or any metallized material having a shiny surface.

A graphic design or image 20 is printed over all or a portion of the layer 18. In the example shown in FIG. 2, the graphic design includes a sports FIG. 30 and a solid colored background 60. Subsequently there may be printed a transparent design or texture 29 (FIGS. 1 and 2), of thick transparent ink, that accents and highlights the image of the sports FIG. 30. Sections 22 control reflected light and are comprised of a plurality of parallel lines 32 of thick transparent ink, where the direction of parallel lines 32 of thick transparent ink in one section 22 are printed at a different angle than the direction of parallel lines 32 of thick transparent ink 32 in adjacent sections 22 (FIGS. 1 and 2). The lines 32 are very narrow in terms of width, but very thick in terms of height, and are spaced very closely together, so as to reflect light in various directions in the different sections. In the preferred embodiment, the height of the lines is approximately 0.005 to 0.010 inches and the spacing between the lines is approximately 0.005 to 0.016 inches. Line heights of up to 0.008 inches or greater are achieved when optimum line angles are used to compensate for digital and mechanical error sources according to the invention. The thickness, width and spacing of the lines may vary depending upon the particular application and desired visual effect, but the extreme effects of the present invention are not achieved using prior art methods and apparatus.

The sections 22 of parallel lines 32 can be formed over the entire surface of the image 20 or over only a portion thereof. The lines 32 are formed from a transparent ink suitable for use in this application, printed on top of the graphic design or image 20 by a printing method such as silk screening, lithography, flexography, offset printing, gravure, coating or other known printing method. This transparent ink is preferably a UV curable ink. The transparent ink may also include flakes of glitter, or pearls, or other materials to produce a “glittery” effect on the printed article.

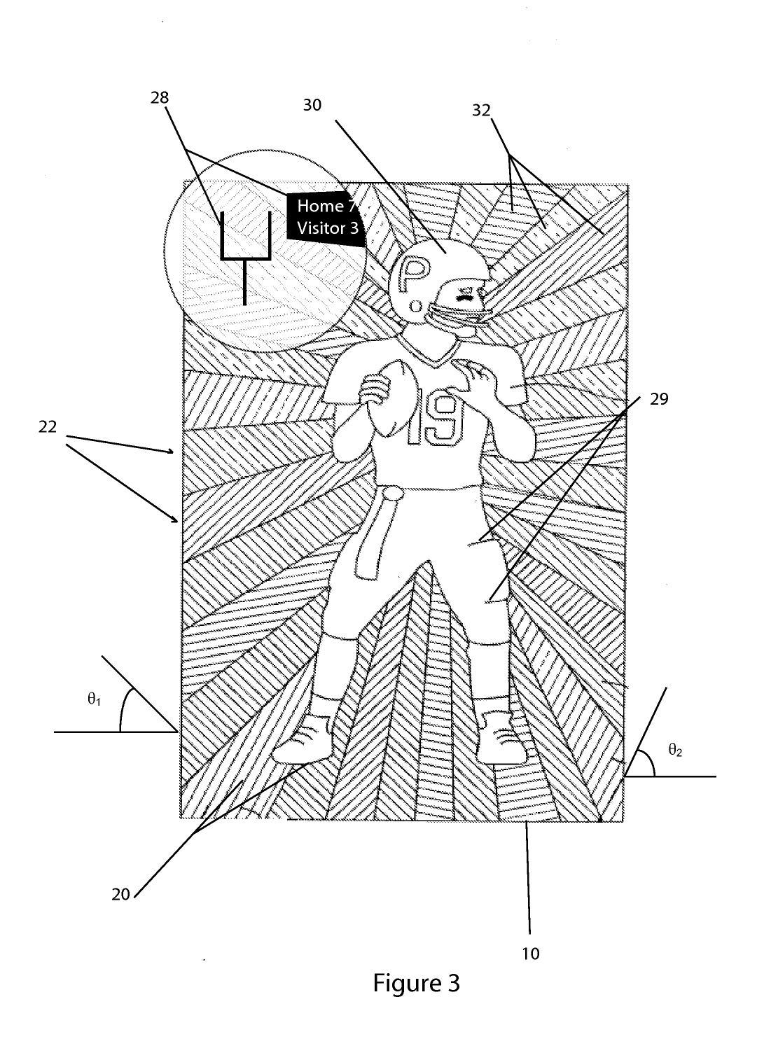

The graphic design 20 can have any desired form, for example, a football player on a sports trading card as shown in FIG. 2, or any other image. The graphic design 20 may comprise a plurality of ink layers in order to provide a desired appearance. The graphic design 20 may also include one or more hidden or latent images 28 printed within the design. These latent images 28 are “weak” or “lightly” printed images shown in FIG. 1 and FIG. 3 that are printed among the plurality of ink layers of the graphic design as shown in FIG. 1 and are visible only at certain viewing angles. The latent images 28 appear and disappear from a viewer as the viewing angle of the printed article 10 is changed.

A preferred method of forming the graphic design 20 and latent images 28 is through a four-color offset printing process where a base layer is printed and a four-color image is printed over the base layer. The graphic design 20 and latent images 28 may be printed with opaque ink, semi-transparent ink, translucent ink, or any combination thereof, although the preferred embodiment uses a select opaque layer 26 printed above the reflective layer 18 and below the latent image 28. These inks are preferably curable in response to ultraviolet (UV) light. Other methods of forming the graphic design 20 and hidden images 28 include silk screening, lithography, flexography, gravure or other known printing methods. In addition, as described above, the thick transparent texture 29 can be printed over and/or around the graphic design or image 20, FIG. 2. The thick transparent texture 29 is typically created to add depth and dimension to the image using the same thick transparent ink used to create the parallel lines 32.

As illustrated in FIG. 2, the angles θ₁ and θ₂ of the parallel lines 32 relative to the direction of certain errors in the production process are selected based on minimizing and compensating for these errors. Examples of such errors are directions of printing, shear, squeegee movement, and anilox or gravure etching, besides film output errors and digital raster image processing errors. The result of selecting these angles on those bases achieves heretofore unachievable texture height and close packing together of parallel lines 32 of the transparent texture ink within each section 22, while still preventing bleeding, flooding, and undesirable flow of the transparent texture ink from one line to the next.

Preferably, the most efficient and direct method of selection of the angles θ₁ and θ₂ of the parallel lines 32 is to run a test pattern to determine the parallel line angles which prevent ink from bleeding from the parallel lines. A series of tests at increasing ink heights may be applied during these test runs to more readily determine what line heights can be achieved at particular angles. Similarly, testing can be directed to angles which achieved desired line thickness, separation/gap or printing speed requirements.

The pattern or transparent texture 29 outlining the sport character gives the appearance of a raised or embossed effect, which simulates depth and three-dimensionality. The sections 22, of parallel semi-cylindrically shaped raised ridges or lines 32 bend and reflect light incident on the printed article 10 producing the visual illusion of depth, three-dimensionality, hidden images and motion through hue and color changes in the printed article as it is viewed from different angles. Light incident on the printed article 10 is reflected off the reflective layer 18 back through the graphic design or image 20 and the transparent texture 29 to create a unique visual effect. Each section 22 of parallel lines 32 are all oriented in the same direction in a given section to illuminate this entire section of printed lines when light is reflected from the reflective layer 18 through the textured pattern of lines. Adjacent sections 22 have parallel lines oriented in different directions to reflect light in different directions as the printed article 10 is viewed from different angles. These different sections 22 of textured patterns of lines create the illusion of motion of reflected light, depth and dimensionality, with images in the printed article 10 appearing and disappearing as it is viewed from different angles. And because the angles of the lines 32 have been selected to be the angles at which the output devices are most exacting, the effect is increased over anything that has been done before.

FIG. 3 depicts the same construction as FIG. 2, where a hidden image 28 becomes visible when the viewing angle is such that light is not reflected toward the viewer from lines 32.

FIG. 4 shows another embodiment of the present invention where a transparent texture 129 and/or sections 122 of parallel lines 132 of transparent ink have physically impressed the transparent texture design into an image 120, into a reflective layer 118, and into a substrate 112. FIG. 4 is a cross-sectional view of this embodiment of the present invention showing the impression of the texture 129 into the reflective surface 118. The substrate 112 is comprised of a thermoplastic material, preferably selected from the following group: polypropylene, polyethylene, polyester, polycarbonate and polyvinylchloride. The reflective layer 118 is printed or laminated to the surface 114 of the thermoplastic substrate, and the graphic image 120 is printed or otherwise applied onto the surface 121 of the reflective layer. The transparent texture 129 and/or sections 122 of transparent parallel lines 132 are printed using traditional printing methods and equipment to create the lines, such as silk screen, lithography, flexography, and ink jet, and are preferably composed of or cured into non-thermoplastic material. A thermoplastic material is possible for use as the texture 129 and/or parallel lines 132 but only if the melting point of the thermoplastic material is sufficiently greater than that of the substrate 118 such that when pressure and or heat is applied to the combined layers, the texture 129 and/or parallel lines 132 will deform the substrate 118 prior to any melting of the texture 129 and/or parallel lines 132. For example, with a polyethylene substrate 118 having a melting point of about 220 degrees Fahrenheit, the texture 129 and/or parallel lines 132 should have a melting point preferably at least 25 degrees Fahrenheit higher, or at least 245 degrees Fahrenheit. Thus, in the preferred embodiment where the transparent texture 129 and/or parallel lines 132 are non-thermoplastic, when pressure and or heat is applied to the combined layers, the non-thermoplastic texture 129 and parallel lines 132 remain in a solid state, and the pressure causes the non-thermoplastic elements to deform reflective layer 120 with the pattern of the texture 129 and/or parallel lines 132 as seen in FIG. 4.

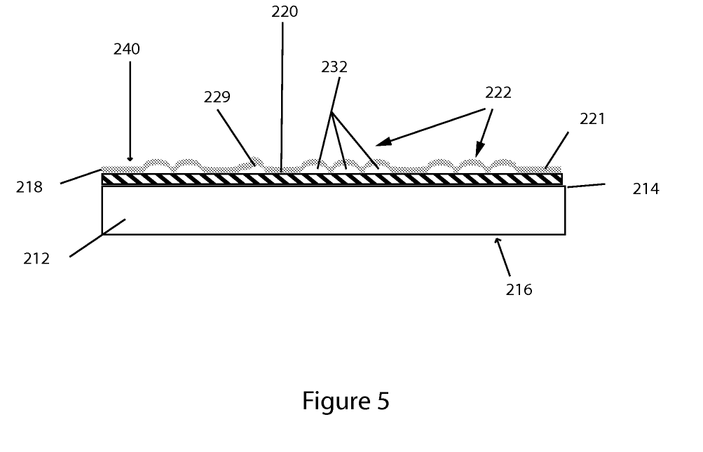

FIG. 5 demonstrates another embodiment of the present invention where a transparent substrate 212 may or may not be printed with an image 220 onto surface 214, the transparent texture design 229 and/or sections 222 of transparent parallel lines 232 are printed onto the image 220 (or if desired can be printed directly onto surface 214 of the transparent substrate), and vacuum metallization is used to vapor deposit a preferably aluminum reflective layer 218 such that the deposited reflective layer substantially conforms to the transparent texture design 229 and/or sections 222 of transparent parallel lines 232. When viewed from either the top 240 or bottom surface 216, the reflective surface appears embossed with the texture design 229 and/or sections 222 of parallel lines 232.

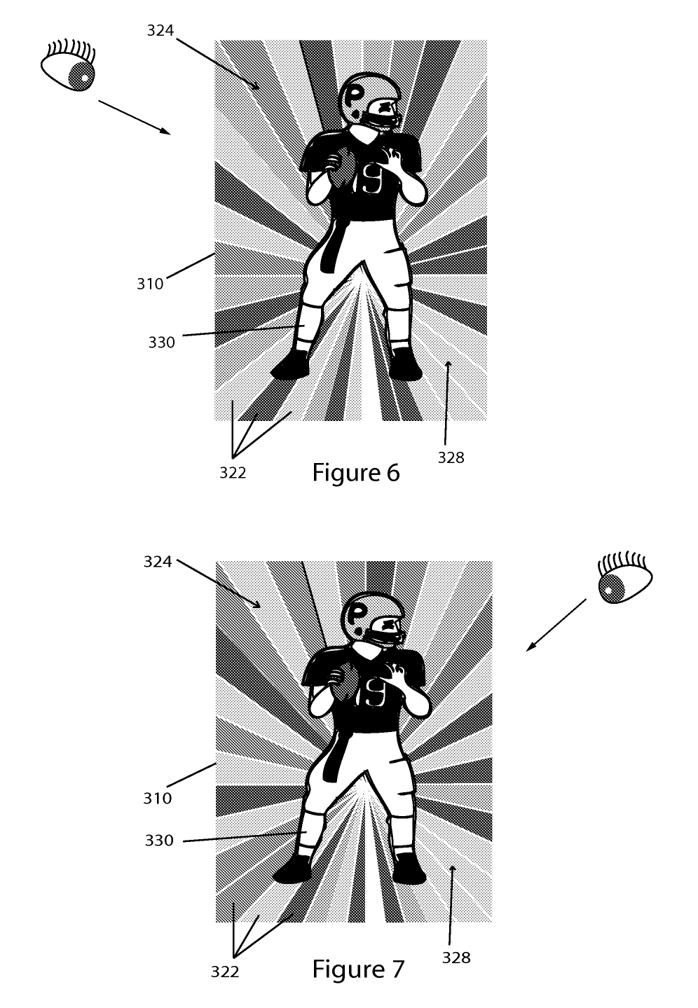

FIGS. 6 and 7 demonstrate two different end results of copying, photographing, or reproducing an image made in accordance with the present invention, for example as shown in FIG. 1. FIG. 6 shows the resulting image when viewed from one angle of light reflection, whereas FIG. 7 shows another copy of the same printed article wherein the light was originating from a different angle. As reproduction methods require reflected light, a copy, photograph, reproduction, or counterfeit 310 of a printed article, with background 324 surrounding the image of a sports FIG. 330, results in different shades of color 322 (or different shades of gray in a monochrome reproduction) than the originally solid background 28. These different shades of color 322 are visible in the counterfeit printed article 310 corresponding to the different reflectivities of the transparent sections of parallel lines (correlating to sections 22 made up of parallel lines 32 from FIGS. 1 and 2) in the original. In comparing FIG. 6 with FIG. 7, it should be noticed that the three sections 322 are different shades in FIG. 6 than in FIG. 7. Thus it is possible, using this invention, to effectively prevent accurate copy, duplication or photographic reproduction of the background, depicted in this example FIGS. 6 and 7 as different shades of color or gray, whereas in the original printed article 10 (FIG. 1) the background 28 was printed with a single, solid color.

While the invention has been described with reference to preferred embodiments, those skilled in the art will appreciate that certain substitutions, alterations, and omissions may be made without departing from the spirit of the invention. Accordingly, the foregoing description is meant to be exemplary only and should not limit the scope of the invention set forth in the claims.

1. A printed article comprising:
a substrate having a top surface;
a graphic image formed over the top surface of the substrate; and
a textured pattern formed of a plurality of lines, formed in adjacent sections over the surface of the graphic image opposite the substrate, wherein said plurality of lines of a section are all substantially parallel to each other and oriented in a first direction, and the plurality of lines of a directly said adjacent section are all substantially parallel to each other and oriented in a second direction different from said first direction, such that said plurality of parallel lines in each section reflect light in a direction different than that of said adjacent section, each of said directions being selected so as to minimize any errors introduced by equipment used to create the lines.

2. A printed article as recited in claim 1 wherein each of the lines has a predetermined thickness, and a predetermined spacing between itself and adjacent lines, and wherein line thickness and spacing have been selected so as to eliminate certain directions of the lines from said texture design, so as to prevent material used to form said adjacent lines from flowing together.

3. The printed article of claim 2 wherein a graphic image includes a plurality of ink layers comprising
a reflective surface formed with at least one opaque ink;
a latent image lightly formed over said reflective surface; and
said textured pattern printed over said latent image, such that reflected light from the surface of said texture pattern effectively prevents visualization of said latent image and said latent image becomes visible when viewed at an angle where light is not reflecting from said textured pattern.

4. The printed article of claim 1 wherein
the substrate is formed of a thermoplastic material with a reflective surface;
said textured design is formed of a transparent non-theromoplastic ink printed onto said substrate;
wherein said non-thermoplastic ink is embossed down into said thermoplastic material using heat and/or pressure to effectuate an embossing of said non-thermoplastic ink into said thermoplastic material.

5. The printed article of claim 1 further comprising a reflective layer formed by vacuum metallization deposit of a metal vapor onto said substrate before the application of said graphic image such that said reflective layer of said deposited metal vapor appears as if said reflective layer is embossed with said textured pattern.

6. A method of forming a printed article, the method including the steps of
providing a substrate having a top surface;
forming a graphic image over the top surface; and
forming a textured pattern of parallel lines in sections over the graphic image, wherein the lines of each said section are all substantially parallel to each other and oriented in a first direction, and the lines of a directly adjacent said section are all substantially parallel to each other and oriented in a second direction different from the first direction, and
selecting each of said directions so as to minimize any errors introduced by equipment used to create the lines.

7. A method as recited in claim 6 further comprising forming each of the said lines with a predetermined thickness, and a predetermined spacing between itself and said adjacent lines, and wherein the thickness and spacing of said lines have been selected so as to eliminate certain directions of said lines from said design, thereby preventing said material used to form adjacent lines from flowing together.

8. The method as recited in claim 6 wherein the step of forming the graphic image includes:
forming a reflective surface with at least one opaque ink;
lightly forming a latent image over said reflective surface; and
printing a textured pattern over said latent image, such that reflected light from said reflective surface of said texture pattern effectively prevents visualization of said latent image and said latent image becomes visible when viewed at an angle where light is not reflecting from said textured pattern.

9. The method as recited in claim 6 further comprising:
forming a substrate of a thermoplastic material with a reflective surface;
forming a textured design of a transparent non-theromoplastic ink printed onto said substrate; and
embossing said non-thermoplastic ink down into said thermoplastic material using heat and/or pressure.

10. The method of claim 6 further comprising forming a reflective layer by vacuum metallization deposit of a metal vapor onto said substrate before the application of a graphic image such that said reflective layer of said deposited metal vapor appears as if said reflective layer is embossed with said textured pattern.

11. The printed article formed by means of the method of claim 6.
